(19) United States
(12) Patent Application Publication
(10) Pub. No.: US 2008/0318071 A1
(43) Pub. Date: Dec. 25, 2008

(54) METALLIC COATING ON SUBSTRATE

(75) Inventors: John Charles Holzheimer, Chagrin Falls, OH (US); Harshil Parikh, North Olmsted, OH (US); Inho Song, Chesterland, OH (US)

Correspondence Address: CALFEE HALTER & GRISWOLD, LLP, 800 SUPERIOR AVENUE, SUITE 1400, CLEVELAND, OH, 44114, US

(73) Assignee: MOEN INCORPORATED, North Olmsted, OH (US)

(21) Appl. No.: 12/139,875

(22) Filed: Jun. 16, 2008

Related U.S. Application Data
(60) Provisional application No. 60/945,441, filed on Jun. 21, 2007.

(51) Int. Cl. B32B 15/00; B05D 3/00; B05D 5/00; B05D 7/24; C25D 13/00; B05D 3/10; B05D 1/00

(52) U.S. Cl. 428/457; 427/331; 427/258; 204/471; 427/203; 427/337; 427/372.2; 427/294

(57) ABSTRACT

Methods of applying metallic coatings to non-metallic, non-conductive, chemically active, corrosion-susceptible or otherwise uncoatable substrates are provided, wherein the metallic coatings strongly adhere to the substrates. First, an intermediate coating is applied on the substrate. Then, the intermediate coating is treated. A metallic coating is subsequently applied on the treated intermediate coating.

### RELATED APPLICATION

The present application is being filed as a non-provisional patent application claiming priority under 35 U.S.C. §119(e) from, and any other benefit of, U.S. Provisional Patent Application No. 60/945,441 filed on Jun. 21, 2007, which is incorporated herein in its entirety by reference.

### FIELD

The invention relates generally to metallic coatings and, more particularly, to methods of applying metallic coatings to substrates and articles incorporating the metallic coatings applied using the methods.

### BACKGROUND

Traditional household articles, such as plumbing fixtures (e.g., spouts), lighting and door/window hardware, have been made of metals, such as brass, zinc or stainless steel. As the price of such metals has increased, the cost to manufacture these items has also increased. Furthermore, regulations may prohibit the use of certain metals in plumbing fixtures. For example, California has adopted legislation that prohibits the water-contacting components of a plumbing fixture from being made of a material containing lead, such as certain leaded brasses. Accordingly, alternative materials have been considered for use in manufacturing traditional metallic household articles. Ceramics are one such alternative. These alternatives are usually lower in cost and/or may be easier to manufacture or otherwise process than metals.

Since consumers continue to request that certain household articles have a metallic appearance, attempts have been made to provide a metallic decorative finish to non-metallic substrates. However, non-metallic materials such as ceramic are generally non-conductive which makes them unsuitable for plating with a metallic coating. Furthermore, even if the ceramic substrate is somehow rendered conductive (e.g., by sensitization as known in the art), a metallic coating deposited on the ceramic substrate adheres poorly thereto. In particular, because of the smoothness of an outer surface of the ceramic substrate, the metallic coating adheres poorly to the ceramic substrate. Furthermore, the hot-cold cycles that a plumbing fixture (as the substrate) undergoes may also contribute to the metallic coating separating from the smooth outer surface of the ceramic substrate.

Conventionally, the outer surface of the ceramic substrate is chemically etched to increase a roughness of the outer surface, thereby improving the adherence of the metallic coating to the ceramic substrate. The chemical etching process that is used has several significant drawbacks. For example, the chemical etching process is a high-temperature process that uses caustic chemicals such as molten inorganic salts and/or hydrofluoric (HF) acid. As a result, the chemical etching process results in a residue that must be cleaned up and is costly.

Another conventional technique is to use an insert molding process to form an intermediate layer on a substrate to render the substrate more suitable for plating with a metallic coating. The insert molding process, however, has several drawbacks. The molds themselves are expensive. Furthermore, the time and/or labor involved in the insert molding process can be long, which further increases the associated costs. Further still, the insert molding process does not work for certain shaped and/or sized components.

In addition to the difficulty in plating non-conductive substrates, as described above, certain conductive substrates are also difficult to plate with a metallic coating. For example, certain metals or alloys thereof (e.g., aluminum, magnesium, or alloys thereof) and semiconductor materials cannot be plated because they are highly chemically active. Accordingly, it is known to apply a special process called zincating to these substrates prior to plating.

Zincating involves pre-coating the substrate with zinc or tin prior to plating the substrate with a metallic coating. Typically, the substrate has zinc chemically deposited thereon by immersion of the substrate in a zincate solution. The zinc coating on the substrate promotes adhesion between the metallic coating and the substrate. A problem with the zincating process, however, is that it does not provide a corrosion barrier to protect the underlying substrate. Thus, the substrate is at risk of corrosion. This is particularly true in the case of plumbing fixtures where moisture is ever present.

Consequently, there is an unmet need in the art for a method of applying a metallic coating to a variety of otherwise uncoatable substrates, wherein the method results in strong adhesion between the metallic coating and the substrate, provides a corrosion barrier that protects the substrate, does not create a residue needing disposal and is relatively inexpensive.

### SUMMARY

In view of the above, it is an exemplary aspect to provide a method of applying a metallic coating to a non-metallic, non-conductive, chemically active, corrosion-susceptible or otherwise uncoatable substrate. The phrase “uncoatable substrate,” as used throughout the specification, means a substrate which after coating will have an unacceptable performance in service. The performance may be unacceptable because a metallic coating will not adhere or will adhere only poorly such that after application of the metallic coating to the substrate the metallic coating may begin to separate from the substrate. Alternatively, the performance may be unacceptable because the coating does not adequately impede the progress of corrosion and/or chemical degradation.

It is another exemplary aspect to provide a method of applying a metallic coating to a non-metallic, non-conductive, chemically active, corrosion-susceptible or otherwise uncoatable substrate using an intermediate coating. The method includes applying the intermediate coating on the substrate and then treating the intermediate coating before applying the metallic coating on the intermediate coating.

It is a further exemplary aspect to provide a method of applying a metallic coating on a substrate using an intermediate coating that includes a first component and a second component. The treatment of the intermediate coating includes removing a portion of the first component from the intermediate coating while leaving a substantial portion of the second component intact.

It is yet another exemplary aspect to provide a method of applying a metallic coating on a substrate using an intermediate coating that includes a first component. The treatment of the intermediate coating includes removing a portion of the first component from the intermediate coating while leaving another portion of the first component intact.

It is an additional exemplary aspect to provide a method of applying a metallic coating on a substrate using an intermediate coating that includes a first component. The treatment of the intermediate coating includes altering the first component of the intermediate coating.

It is still another exemplary aspect to provide an article of manufacture (e.g., a plumbing fixture, a door fixture, a window fixture, a lighting fixture) formed from any of the methods relating to the general inventive concept as disclosed herein

### BRIEF DESCRIPTION OF THE DRAWINGS

The above aspects and additional aspects, features and advantages will become readily apparent by describing in detail exemplary embodiments thereof with reference to the attached drawing:

FIG. 1 is a flowchart of a method of applying a metallic coating to a non-metallic, non-conductive, chemically active, corrosion-susceptible or otherwise uncoatable substrate, according to an exemplary embodiment.

### DETAILED DESCRIPTION

While the general inventive concept is susceptible of embodiment in many different forms, there are shown in the drawing and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

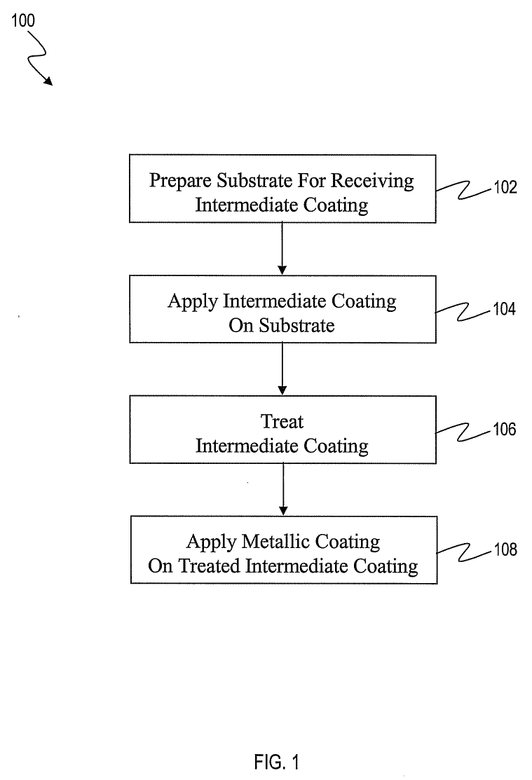

FIG. 1 is a flowchart illustrating the steps of a method 100 of applying a metallic coating to a non-metallic, non-conductive, chemically active, corrosion-susceptible or otherwise uncoatable substrate, according to one exemplary embodiment.

In step 102 shown in FIG. 1, the substrate (e.g., a non-metallic, non-conductive substrate such as a ceramic, a plastic, or a wood substrate; or a chemically-active substrate such as an aluminum alloy or a magnesium alloy substrate) is prepared prior to application of an intermediate coating. The preparation of the substrate may include cleaning of its surface to remove adhesion-spoiling contaminants such as oil, which may be followed by application of an adhesion promoter to facilitate the intermediate coating adhering to the substrate. As one example, the substrate can be dipped into a silane solution. Treating the substrate with silane promotes adhesion between the intermediate coating and the substrate because the silane forms a strong chemical bond with both the substrate and the intermediate coating. In one exemplary embodiment, the step 102 of preparing the substrate for receiving the intermediate coating is optional and may be omitted.

In step 104, the intermediate coating is applied to the substrate. The intermediate coating has better adhesion properties relative to the substrate than a metallic coating. In one exemplary embodiment, the intermediate coating is acrylonitrile-butadiene-styrene (ABS), which is a common thermoplastic. ABS is but one example of a suitable intermediate coating. For example, any other plastic or composition capable of being treated (as described below relative to step 106) could function as the intermediate coating. Preferably, the intermediate coating that is used exhibits strong corrosion resistance such that it acts as a barrier that protects the substrate from corrosion. The intermediate coating is applied to the substrate, for example, using one of dip coating, spray coating, powder coating, electrophoretic coating or autophoretic coating.

The intermediate coating is applied to at least an outer surface of the substrate. In one exemplary embodiment, the intermediate coating is allowed to also coat surfaces other than the outer surface of the substrate. In another exemplary embodiment, the intermediate coating is prevented from coating surfaces other than the outer surface of the substrate. The intermediate coating can be applied to the substrate in any manner suitable to coat at least the outer surface of the substrate.

In one exemplary embodiment, the intermediate coating is ABS and is applied to the substrate by dip coating. In ABS dip coating, ABS is dissolved in an organic solvent such as acetone to form an ABS solution. The substrate is then dipped in the ABS solution so that a film of the ABS solution forms on the substrate. The organic solvent is allowed to evaporate from the film of the ABS solution on the substrate thereby leaving the substrate coated with ABS.

In another exemplary embodiment, the intermediate coating is ABS and is applied to the substrate by spray coating. In ABS spray coating, ABS is dissolved in an organic solvent such as acetone to form an ABS solution. The ABS solution is then sprayed onto the desired surfaces of the substrate. The organic solvent is allowed to evaporate from the ABS solution sprayed on the substrate thereby leaving the substrate coated with ABS.

In yet another exemplary embodiment, the intermediate coating is ABS and is applied to the substrate by powder coating. In ABS powder coating, solid ABS is finely ground into an ABS powder. The ABS powder is then sprayed onto the desired surfaces of the substrate. Electrostatic forces retain the ABS powder on the coated surfaces of the substrate. The substrate with the ABS powder thereon is subsequently heated to affix the ABS coating on the substrate.

After the intermediate coating is applied to the substrate in step 104, the intermediate coating is treated in step 106. Treating the intermediate coating changes the surface characteristics of the intermediate coating, thereby making the intermediate coating more suitable for adhering to a metallic coating.

In one exemplary embodiment, the intermediate coating includes a first chemical component and a second chemical component. The intermediate coating is treated by removing (e.g., chemically or physically) at least a portion, and in one exemplary embodiment a substantial portion, of the first chemical component from the intermediate coating without removing a substantial portion of the second chemical component.

In one exemplary embodiment, the intermediate coating is an ABS coating. After the ABS coating is applied to the substrate in step 104, the ABS coating is etched in step 106. Etching the ABS coating changes the surface characteristics of the ABS coating. Etching the ABS coating involves applying an etchant (i.e., a solution) that removes a portion, and in one exemplary embodiment a substantial portion, of at least one component of the ABS coating (e.g., the butadiene) and leaves a substantial portion of at least one component (e.g., the acrylonitrile and/or the styrene) of the ABS coating intact. In one exemplary embodiment, the etchant is an acid with a pH of less than 4. The resulting structure is an intermediate coating with an increased surface roughness (e.g., a microscopic surface roughness) due to the porosity of the intermediate coating at its surface where the etchant removed the butadiene.

In another exemplary embodiment, the intermediate coating includes a first chemical component. The intermediate coating is treated by removing (e.g., chemically or physically) a portion of the first chemical component from the intermediate coating without removing another portion of the first chemical component.

In yet another exemplary embodiment, the intermediate coating includes a first chemical component. The intermediate coating is treated by altering (e.g., chemically or physically) the first chemical component of the intermediate coating.

In some exemplary embodiments, the resulting structure is an intermediate coating with an increased surface roughness. In other exemplary embodiments, the resulting structure is an intermediate coating which has an altered chemical character. The resulting structure of the intermediate coating promotes adherence of a metallic coating (e.g., copper, nickel, chrome) which is subsequently applied on the intermediate coating in step 108. The metallic coating can be applied to the substrate with the treated intermediate coating in any suitable manner including, for example, plating, vacuum metallization and painting.

Articles (e.g., plumbing fixtures, door fixtures, window fixtures, lighting fixtures) produced by the exemplary method 100 as well as other exemplary methods encompassed by the general inventive concept (hereinafter generally referred to as the “collective methods”) have an outer metallic coating that users may find desirable. The metallic coating is strongly adhered to the underlying substrate (via the intermediate coating) and remains so even if the substrate is exposed to varying temperatures, as temperature variation frequently accelerates delamination between the substrate and the coating because of differential thermal expansion.

Because an article can be made primarily from a material (e.g., a non-metallic, non-conductive material such as a ceramic) having a lower cost than an alternative metal, the material cost associated with the article can be reduced. Furthermore, the article can be made such that water-contacting surfaces (e.g., of a substrate) of the article do not contain lead. Further still, irrespective of any costs involved, application of the intermediate coating can provide a corrosion barrier that protects the article from corrosion. Yet further still, because the article has a thin outer metallic coating, the article exhibits a metallic appearance to the users thereof.

The collective methods do not involve high-temperature processes like in conventional etching or only involve reduced-temperature processes relative to conventional etching. In one exemplary embodiment, a step of treating the intermediate coating occurs within a temperature range of 40 degrees Fahrenheit to 180 degrees Fahrenheit. The collective methods do not involve the expensive chemicals required in conventional etching or only involve less expensive chemicals than used in conventional etching. The collective methods do not produce residues that require time and money to be cleaned and discarded.

Consequently, the collective methods can produce articles that include a metallic coating applied to a non-metallic, non-conductive, chemically active, corrosion-susceptible or otherwise uncoatable substrate with strong adhesion between the metallic coating and the substrate, while being less messy and/or less expensive than conventional etching. Additionally, the collective methods can produce articles that are resistant to corrosion.

The above description of specific embodiments has been given by way of example. From the disclosure given, those skilled in the art will not only understand the general inventive concept and its attendant advantages, but will also find apparent various changes and modifications to the structures and methods disclosed. It is sought, therefore, to cover all such changes and modifications as fall within the spirit and scope of the general inventive concept, as defined herein, and equivalents thereof.

What is claimed is:

1. A method of coating a substrate that is at least one of non-metallic, non-conductive, chemically active, and corrosion-susceptible, the method comprising:
applying an intermediate coating on the substrate;
treating the intermediate coating; and
applying a metallic coating on the treated intermediate coating.

2. The method of claim 1, wherein the intermediate coating includes a first component and a second component and wherein treating the intermediate coating includes removing a portion of the first component from the intermediate coating while leaving a substantial portion of the second component intact.

3. The method of claim 1, wherein the intermediate coating includes a first component and wherein treating the intermediate coating includes removing a portion of the first component from the intermediate coating while leaving another portion of the first component intact.

4. The method of claim 1, wherein the intermediate coating includes a first component and wherein treating the intermediate coating includes altering the first component of the intermediate coating.

5. The method of claim 1, wherein the substrate is one of ceramic, plastic and wood.

6. The method of claim 1, wherein the substrate is one of an aluminum alloy and a magnesium alloy.

7. The method of claim 1, wherein the substrate experiences hot and cold temperature cycles.

8. The method of claim 1, wherein the intermediate coating is a plastic.

9. The method of claim 1, wherein the intermediate coating is acrylonitrile-butadiene-styrene.

10. The method of claim 9, wherein the first component is butadiene.

11. The method of claim 1, wherein the intermediate coating is applied to only an outer surface of the substrate.

12. The method of claim 1, wherein the intermediate coating protects the substrate from corrosion.

13. The method of claim 1, wherein the intermediate coating is applied on the substrate by one of dip coating, spray coating, powder coating, electrophoretic coating and autophoretic coating.

14. The method of claim 1, wherein treating the intermediate coating includes applying a solution to the intermediate coating.

15. The method of claim 14, wherein the solution is an acid with a pH of less than 4.

16. The method of claim 1, wherein treating the intermediate coating occurs within a temperature range of 40 degrees Fahrenheit to 180 degrees Fahrenheit.

17. The method of claim 1, wherein the metallic coating is one of copper, nickel and chrome.

18. The method of claim 1, wherein the metallic coating is applied on the intermediate coating by one of plating, vacuum metallization and painting.

19. An article of manufacture comprising:
a substrate that is at least one of non-metallic, non-conductive, chemically active, and corrosion-susceptible;
a treated intermediate coating on the substrate; and
a metallic coating on the treated intermediate coating.

20. The article of claim 19, wherein the article is at least one of a plumbing fixture, a door fixture, a window fixture, and a lighting fixture.
